(19) United States
(12) Patent Application Publication
(10) Pub. No.: US 2009/0003674 A1
(43) Pub. Date: Jan. 1, 2009

(54) Sense Mr Parallel Imaging With Continuously Moving Bed

(75) Inventors: Jochen Keupp, Hamburg (DE); Peter Boernert, Hamburg (DE); Bernd Aldefeld, Hamburg (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 11/909,167

(22) PCT Filed: Mar. 27, 2006
(86) PCT No.: PCT/IB2006/050928

§ 371 Date: Sep. 20, 2007

Related U.S. Application Data
(60) Provisional application No. 60/668,890, filed on Apr. 6, 2005.

(51) Int. Cl. G06K 9/54

(52) U.S. Cl. 382/131

(57) ABSTRACT

During continuous moving of an imaging subject (12) through a scanner field of view (20), k-space data are acquired using a plurality of radio frequency coils (24, 26). The acquiring includes undersampling of k-space in at least one undersampled direction. A weighted transform (62) from k-space to real space is defined for at least one undersampled direction. The weighted transform incorporates patient position-dependent coil sensitivity weighting factors and a Fourier transform. The acquired k-space data are hybrid transformed along the direction of continuous moving to define hybrid space data having a real space dimension in the transformed direction of continuous moving and a k-space dimension in a transverse direction that is transverse to the direction of continuous moving. The hybrid space data are transformed along the transverse direction to generate a reconstructed image. The hybrid transforming and the transforming employ the defined weighted transform (62) conditional upon the corresponding direction being undersampled.

The following relates to the magnetic resonance imaging arts. It finds particular application in cancer screening, angiography, and other diagnostic imaging procedures advantageously performed over the whole body or large portions thereof, and will be described with particular reference thereto. However, it also finds application in continuous moving-table magnetic resonance imaging generally.

Magnetic resonance scanners have a limited fields of view that are typically substantially smaller than the average person. Thus, magnetic resonance imaging is not readily used to perform “whole body” or other extended region-of-interest imaging in which the region of interest is larger than the scanner field of view. This limits the usefulness of magnetic resonance imaging for diagnostic tasks such as cancer screening, angiography, or the like.

One approach for imaging extended regions of interest larger than the scanner field of view is the multi-station method, in which imaging progresses in discrete steps. During each step, one scanner field of view is imaged. Subsequently, the imaging subject is advanced through the scanner bore by a distance equal to the length of the scanner field of view in the axial direction, and another scanner field of view is imaged. The successively imaged fields of view are sewn together to form an image of the extended region of interest. The multi-station method has certain disadvantages. The start-and-stop table motion can be disturbing to the patient, can increase patient movement artifacts, and increases the total imaging session time. Discontinuities are also introduced into the combined image at the boundaries between successive scanner fields of view.

In continuous moving table magnetic resonance imaging, the patient is continuously axially advanced through the scanner bore, typically at a constant table velocity, and magnetic resonance imaging data is acquired during the continuous table advancement. Compared with the multi-station approach, imaging using a continuously moving table is generally faster, reduces or eliminates image discontinuities, and is generally less disturbing to the patient because the table moves continuously rather than in a “start-and-stop” fashion.

Parallel imaging is another technique for performing faster scans. In parallel imaging, a plurality of coils are used to receive the magnetic resonance signal. For example, in sensitivity encoding (SENSE) imaging, k-space is sampled sparsely, and data from the several coils is used to compensate for the sparsity of sampling by any one coil. Using four coils, for example, only every fourth phase-encoding line is acquired. Separate images are reconstructed from the data acquired by each coil, producing a set of four “folded” reconstructed images corresponding to the four coils. These folded images are combined, or unfolded, taking into account coil sensitivity factors, to produce the final image having substantially the same characteristics as if the image data had been acquired by a single coil sampling every phase-encoding line. In this example, about a factor of four increase in imaging speed can be achieved, since only every fourth phase-encoding line is acquired. Based on the number of coils and the SENSE factor, other increases in imaging speed are achievable. Other parallel imaging techniques, such as SMASH, also provide various advantages such as increased imaging speed, higher image resolution, or so forth.

Parallel imaging using a continuously moving table and stationary receive coils is difficult, because the table movement introduces time-dependent coil sensitivity factors as the patient moves through the field of view of the scanner. Instead, movable coils can be used (arranged, for example, on or in the moving table, or placed directly on the patient). However, the whole body of the patient has to be covered with this type of coils, since the table translation will shift the moving coils outside the field of view of the scanner. For some applications, a hybrid arrangement may be desirable, in which some coils of the parallel imaging array are stationary respective to the scanner, while others move with the patient. In these hybrid arrangements, the stationary coils have time-dependent coil sensitivity factors while the movable coils have time-independent sensitivity factors. For parallel imaging using a continuously moving table and stationary or hybrid coil arrangements, standard reconstruction methods (SENSE, SMASH) are not applicable.

The present invention contemplates improved apparatuses and methods that overcome the aforementioned limitations and others.

According to one aspect, an imaging method is provided. An imaging subject is continuously moved through a scanner field of view. During the continuous moving, k-space data are acquired using a plurality of radio frequency coils. The acquiring includes undersampling of k-space in at least one undersampled direction. The acquired k-space data are Fourier transformed along the direction of continuous moving to define hybrid space data having a real space dimension in the transformed direction of continuous moving and k-space dimensions in the transverse directions that are transverse to the direction of continuous moving. The hybrid space data are transformed along the transverse direction to generate a reconstructed image. A weighted transform from the multitude of k-space data of the radio frequency coils to real space is defined for the at least one undersampled direction. The weighted transform incorporates patient position-dependent coil sensitivity weighting factors.

According to another aspect, a magnetic resonance imaging scanner is disclosed, which performs the imaging method of the immediately preceding paragraph.

According to another aspect, a processor is disclosed for performing an image data processing method on k-space data acquired during continuous moving of an imaging subject using a plurality of radio frequency coils and including undersampling of k-space in at least one undersampled direction. The image data processing method performed by the processor includes: hybrid transforming the acquired k-space data along the direction of continuous moving to define hybrid space data having a real space dimension in the transformed direction of continuous moving and a k-space dimension in a transverse direction that is transverse to the direction of continuous moving; defining a weighted transform from k-space of all radio frequency coils to real space for the at least one undersampled direction, the weighted transform incorporating patient position-dependent coil sensitivity weighting factors and including a Fourier transform of the hybrid space data along the transverse direction to generate a reconstructed image; the method employing the defined weighted transform along an undersampled direction.

According to another aspect, a storage medium is disclosed encoding instructions executable by an associated digital processor to perform an image data processing method on k-space data acquired during continuous moving of an imaging subject using a plurality of radio frequency coils and including undersampling of k-space in at least one undersampled direction. The image data processing method includes: hybrid transforming the acquired k-space data along the direction of continuous moving to define hybrid space data having a real space dimension in the transformed direction of continuous moving and a k-space dimension in a transverse direction that is transverse to the direction of continuous moving; defining a weighted transform from k-space of all radio frequency coils to real space for the at least one undersampled direction, the weighted transform incorporating patient position-dependent coil sensitivity weighting factors and including a Fourier transform of the hybrid space data along the transverse direction to generate a reconstructed image; the method employing the defined weighted transform along an undersampled direction.

One advantage resides in faster imaging through a combination of continuous moving table magnetic resonance imaging and parallel imaging.

Another advantage resides in parallel imaging a field of view larger than a scanner field of view through the use of continuous moving table magnetic resonance imaging performed in conjunction with the parallel imaging.

Another advantage resides in facilitating the combination of continuous moving table magnetic resonance imaging and parallel imaging with stationary coils.

Another advantage resides in facilitating the combination of continuous moving table magnetic resonance imaging and parallel imaging with both stationary and moving coils.

Another advantage resides in optional incorporation of coil loading effects into patient position-dependent coil sensitivity weighting factors integrated into the reconstruction.

Numerous additional advantages and benefits will become apparent to those of ordinary skill in the art upon reading the following detailed description of the preferred embodiments.

The invention may take form in various components and arrangements of components, and in various process operations and arrangements of process operations. The drawings are only for the purpose of illustrating preferred embodiments and are not to be construed as limiting the invention.

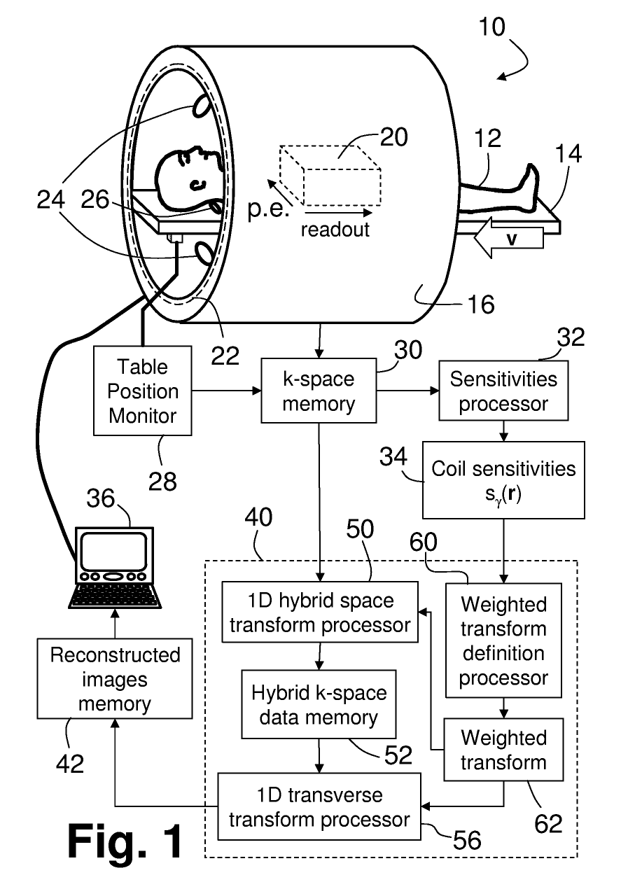

FIG. 1 diagrammatically shows an example continuous moving table magnetic resonance imaging system including parallel imaging using a plurality of magnetic resonance receive coils.

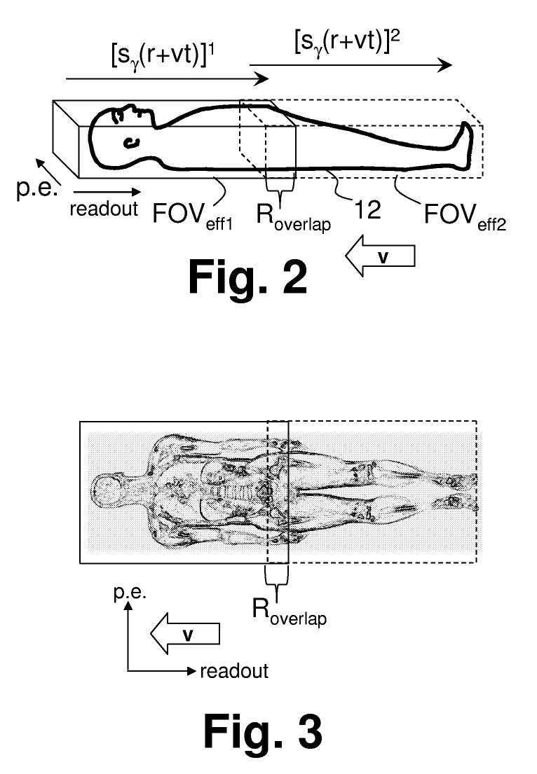

FIG. 2 diagrammatically shows overlapping effective fields of view acquired in two successive scans of the scanner field of view while the imaging subject is continuously moving. FIG. 2 further diagrammatically indicates the patient position-dependent coil sensitivity weighting factors used in the reconstructing of each effective field of view.

FIG. 3 diagrammatically shows the image resulting from the scanning of FIG. 2, with the effective fields of view and the overlap region superimposed.

With reference to FIG. 1, a magnetic resonance imaging scanner 10 images an imaging subject 12 disposed on a continuously moving table or bed 14. The continuously moving table moves at a velocity v indicated by a labeled block arrow in FIG. 1. The magnetic resonance imaging scanner 10 typically includes various components contained in a housing 16 and thus not visible in FIG. 1, such as main magnetic field coils that produce a substantially temporally and spatially constant B₀ magnetic field at least within a scanner field of view 20 (the scanner field of view 20 is blocked from direct view by the scanner housing 16 in the perspective view of FIG. 1, and hence is shown in phantom in FIG. 1) inside of which a portion of the imaging subject 12 is disposed, and magnetic field gradient coils for selectively producing magnetic field gradients at least within the scanner field of view 20.

Additionally, a plurality of radio frequency coils are selectively coupled with the portion of the imaging subject within the scanner field of view 20. In the example FIG. 1, these coils include a quadrature birdcage coil 22 disposed on or in the housing 16; an end-ring of the quadrature birdcage coil 22 is shown in phantom in FIG. 1. The example coils of FIG. 1 also include stationary coils 24 disposed on the scanner housing 16. The example coils of FIG. 1 still further include movable coils 26 embedded in the continuously moving table 14. (Two stationary coils 24 and one movable coil 26 are visible in the perspective view of FIG. 1).

During imaging, the scanner 10 produces the substantially spatially and temporally constant B₀ magnetic field in the scanner field of view 20, and the quadrature birdcage coil 22 injects radio frequency excitations at the ¹H hydrogen Larmor frequency or another suitable magnetic resonance frequency to excite magnetic resonance signals selected portions of the imaging subject 12. The stationary coils 24 are used to acquire magnetic resonance imaging data in a parallel imaging mode. Optionally, the movable coils 26 are also used for the parallel imaging. In another contemplated parallel imaging mode, only the movable coils 26 are used for acquiring the magnetic resonance imaging data. During imaging, the scanner 10 produces magnetic field gradients that encode the magnetic resonance signals along a selected k-space trajectory. Cartesian encoding typically includes a readout direction and one or two phase encoding directions (for two-dimensional and three-dimensional imaging, respectively). Alternatively, three-dimensional imaging can be acquired using a plurality of two-dimensional slice acquisitions. Simultaneously during the imaging, the table 14 is continuously moved at the velocity v. Optionally, the velocity value can be varied for different parts of the patient's anatomy. The position of the table 14 is monitored by a table position monitor 28.

In order to take advantage of the parallel imaging afforded by acquiring k-space data using a plurality of the coils 24, 26 having generally different coil sensitivities, the acquiring should include undersampling of k-space in at least one undersampled direction. For example, if a Cartesian k-space acquisition trajectory is used, undersampling in the phase encoding direction is suitably achieved by omitting some phase encoding lines from the k-space acquisition. By undersampling, the imaging speed is improved. The sparsity of k-space data introduced by undersampling is compensated by including k-space data acquired using more than one coil in the subsequent image reconstruction. The acquired k-space magnetic resonance imaging samples are stored in a k-space memory 30, with each stored k-space sample annotated by a value indicating the position of the table 14 at the time of acquisition of the k-space sample, as provided by the table position monitor 28. Alternatively or additionally, each k-space value can be annotated by a time of acquisition, since the time and table position are related through the velocity v (or the applied multiple velocity values, if different velocities are used for different anatomical regions).

In order to apply parallel imaging, a sensitivities processor 32 performs sensitivities analysis on suitable coil sensitivity calibration data acquisitions to determine coil sensitivities s_{γ}(r) 34 (where r denotes spatial position) of the coils 24, 26. In one suitable approach, the coil sensitivity calibration data acquisitions include image scans acquired using the birdcage coil 22 and using each of the coils 24, 26. Ratioing complex intensity values acquired using each local coil 24, 26 and the corresponding complex intensity values acquired using the birdcage coil 22 provide the coil sensitivities 34. The coil sensitivity calibration data acquisitions are low resolution, and can be acquired prior to the continuous table motion scans, for example by acquiring data for a plurality of fixed positions of the table 14 or by a calibration scan using continuous table motion as well. Alternatively, the low resolution coil sensitivity calibration data acquisitions can be interleaved amongst the acquiring of k-space data during the continuous table motion scan.

With continuing reference to FIG. 1 and with brief reference to FIG. 2, as the imaging subject 12 is continuously moved at the velocity v, one or more scans are acquired within the scanner field of view 20. However, because the imaging subject 12 is moving continuously at the velocity v during acquisition of each scan, the effective field of view of each scan respective to the imaging subject 12 is larger. In general, if each scan of the scanner field of view 20 takes a time T_{scan}, then the effective field of view for each scan respective to the imaging subject 12 is stretched or increased by a factor approximately corresponding to |v|·T_{scan} where |v| is the magnitude of the table velocity. FIG. 2 shows two such effective fields of view FOV_{eff1} and FOV_{eff2}, that have an overlap region Rₒᵥₑᵣₗₐₚ. The scan parameters, such as the scan time T_{scan} and the velocity v, are selected by a radiologist or other use via a user interface 36.

With returning reference to FIG. 1, a reconstruction processor 40 reconstructs the parallel imaging data acquired with the table 14 continuously moving to produce a reconstructed image that is stored in a reconstructed images memory 42. The undersampling of k-space in the at least one undersampled direction is compensated by including k-space data acquired by the plurality of radio frequency coils in the reconstruction. However, because of the continuous moving, the coil sensitivities are in general time-dependent, and so the usual SENSE-type unfolding in image space cannot be performed accurately. Rather, as will be described herein, patient position-dependent coil sensitivity weighting factors are incorporated directly into the k-space-to-real space transforms, allowing the time-dependence of the coil sensitivities to be properly accounted for. The reconstructed image is suitably displayed on the user interface 36 or on another higher resolution display device, or is printed, communicated over the Internet or a local area network, stored on a non-volatile storage medium, or otherwise used.

The reconstruction processor 40 performs reconstruction of the parallel imaging data accounting for the coil sensitivities 34 and the continuous movement of the table 14. A one-dimensional hybrid space transform processor 50 Fourier transforms the acquired k-space data along the direction of continuous moving (that is, parallel with the table velocity v) to define hybrid space data having a real space dimension in the transformed direction of continuous moving and retaining k-space dimensions in transverse directions that are transverse to the direction of continuous moving. In the illustrated imaging, the k-space acquisition uses Cartesian k-space trajectories with the readout direction corresponding to the direction of continuous moving and a labeled phase encoding (p.e.) direction corresponding to a transverse direction. For three-dimensional imaging, a second (unlabeled) phase encoding direction can be employed transverse to both the readout and the labeled p.e. directions. This third direction is suitably processed during reconstruction analogously to the described processing of the labeled p.e. direction. Aligning the readout direction with the continuous movement direction is advantageous in that data is easily oversampled in the readout direction which facilitates reconstructing transition-free images. However, other k-space trajectories can be used, such as a k-space trajectory employing phase encoding along the direction of continuous movement.

The hybrid space data is stored in a hybrid space data memory 52. A transverse transform processor 56 transforms the hybrid space data along the transverse directions to generate the reconstructed image that is stored in the reconstructed images memory 42. If two phase encoding directions are used for three-dimensional imaging (one or both of which may be sub-sampled), then one-dimensional transforms are performed along each phase encoding direction.

In one suitable embodiment, the one-dimensional hybrid space transform processor 50 Fourier transforms the acquired k-space data along the direction of continuous moving to produce uncorrected hybrid space data, and adjusts the uncorrected hybrid space data for the continuous moving to generate the hybrid space data. The corrective adjustments for the continuous moving are based on the table position values annotated to the acquired k-space data by the table position monitor 28, or equivalently are based on annotated acquisition times along with the known speed of the table velocity v. Suitable corrective adjustment techniques are described, for example, in Kruger et al., “Continuously Moving Table Data Acquisition Method for Long FOV Contrast-Enhanced MRA and Whole Body MRI”, Magnetic Resonance in Medicine (MRM) volume 47, pages 224-31 (2002). After correcting for the continuous moving, the hybrid space data corresponds to the frame of reference defined by the imaging subject 12. Accordingly, application of the transverse transform processor 56 transforms the hybrid space data into the reconstructed image.

However, because the k-space data is undersampled in at least one phase encoding direction, the transform processors 50, 56 should take into account the coil sensitivities to compensate for the undersampling by combining k-space data from the plurality of radio frequency coils 24, 26. The coil sensitivities s₆₅ (r) 34 are measured by the sensitivities processor 32. To account for the continuous moving, a weighted transform definition processor 60 constructs patient position-dependent coil sensitivity weighting factors that are functionally dependent upon the reference position value r (s_{γ}(r) 34 having been measured by the sensitivities processor 32 for a plurality of reference positions r corresponding to a plurality of table positions) offset by a spatial shift v·t produced by continuous movement at the velocity v for the time t. The patient position-dependent coil sensitivity weighting factors are directly incorporated into the k-space-to-real space transform to define a weighted transform 62 for the at least one undersampled direction.

The illustrated embodiment is used as an example. In the illustrated embodiment, the readout direction is antiparallel with the table velocity v, while the phase encoding direction is transverse to the table velocity v. The phase encoding direction is undersampled to provide SENSE-type data, but with the additional continuous moving superimposed on the acquired k-space data. The one-dimensional hybrid space transform processor 50 applies a Fourier transform to the acquired k-space data along the readout direction without making use of coil sensitivity factors, and makes the corrective adjustment for the continuous moving. This produces hybrid space data having the readout direction transformed into real space but the undersampled phase-encoding direction retained in a k-space coordinate. For the stationary coils 24 that do not follow the continuous moving, a one-dimensional weighted transform 62 suitable for application in the phase encoding direction corresponds to solving the matrix equation:

$${m}_{i , γ , κ , λ}^{hyb} = {\sum }_{λ} {E}_{i , γ , κ , λ} \cdot {ρ}_{i , λ} , \qquad ( 1 )$$

for the real-space signal density ρ_{i, λ}, where m_{i, γ, κ, λ}^{hyb} denotes the hybrid space data, i indexes phase-encoding lines in the hybrid space data, λ indexes lateral positions along the phase-encoding lines of the hybrid space data, ρ_{i, λ} denotes the signal density in line i at lateral position λ, γ indexes the plurality of radio frequency coils, κ indexes phase-encoding line acquisitions, and E_{i, γ, κ, λ} is an encoding matrix corresponding to:

E_{i, γ, κ,λ}=s_{γ}(r_{i, λ}−v·t_{κ})·exp(ik(t_{κ})·r_{i, λ}) (2),

where v denotes the velocity of the continuous moving, k(t_{κ}) denotes a phase-encoding step, t_{κ} denotes the time of acquisition of the phase-encoding line acquisition indexed by κ, r_{i, λ} denotes the spatial position corresponding to line i and lateral position λ, and S_{γ} denotes coil sensitivities. The sensitivity encoding and Fourier encoding aspects of the encoding matrix E_{i, γ, κ, λ} are not separable because of the time (or equivalently, patient position) dependence; rather, E_{i, γ, κ, λ} has to be fully inverted. Pseudo-inverse matrices can be computed using, for example, LU-decomposition, and Equation (1) is solved line by line for the real-space signal density p_{i, λ}.

Coil sensitivity data are treated depending on the coil type. The patient position-dependent coil sensitivity weighting factors for the stationary coils 24 that do not follow the continuous moving shift the sensitivity in accordance with the position of recording of the phase encoding steps, as indicated by the term s_{γ}(r_{i, λ}−v·t_{κ}). For the moving coils that do follow the continuous moving, the part of the sensitivity pattern which is currently inside the scanner field of view 20 is selected, thus defining patient position-independent coil sensitivity weighting factors of the form s_{γ}(r_{i, λ}).

The imaging is typically done by acquiring a plurality of scans of the scanner field of view 20 during the continuous moving. The transform processors 50, 56 are applied to each scan of the scanner field of view 20 to produce a corresponding reconstructed image for each scan. If the stationary coils 24 are used exclusively for the parallel imaging, then the same weighted transform 62 can be used in the reconstruction of each scan. That is, there is no need to redefine the weighted transform 62 for each scan, since it will be the same for each scan. On the other hand, if both the stationary coils 24 and the moving coils 26 are used in the parallel imaging, then translation of the moving coils 26 through (and perhaps out of) the scanner field of view 20 will generally dictate redefining the weighted transform 62 for each scan.

Optionally, the weighted transform 62 also takes into account time- or patient position-dependent coil loading effects caused by the continuous moving of the generally spatially non-uniform imaging subject 12 through the scanner field of view 20. For example, if the sensitivities processor 32 operates on coil sensitivity calibration data acquisitions acquired with the imaging subject 12 in position, then the resulting coil sensitivities 34 will include the effects of loading the coils with the imaging subject 12. In this case, even if only the stationary coils 24 are used, it will be advantageous to redefine the weighted transform 62 for each subsequent scan to account for variations in the coil loading as the imaging subject 12 moves through the scanner field of view 20.

By properly selecting the table velocity v respective to the length of the scanner field of view 20 in the direction of continuous moving, it is possible to arrange for spatially neighboring images reconstructed from succeeding scans of the scanner field of view 20 to precisely abut, thus creating an enlarged field-of-view combined scan including the effective fields of view of the succeeding scans. However, at the point of abutment image discontinuities may occur. Oversampling in the direction of continuous movement (the readout direction in the example k-space trajectory) enables the succeeding scans to be smoothed at the abutment interfaces.

Hence, with reference to FIG. 2, it is advantageous to select the table velocity v to provide partial overlap of spatially neighboring reconstructed images. In the illustrated example of FIG. 2, FOV_{eff1} and FOV_{eff2} of two succeeding scans overlap in image space by an amount Rₒᵥₑᵣₗₐₚ. This redundancy can be used to smooth the discontinuity between the two neighboring images. FIG. 2 also diagrammatically indicates for the scan of FOV_{eff1} the patient position-dependent coil sensitivity factor denoted [s_{γ}(r+vt)]¹, and for the scan of FOV_{eff2} the patient position-dependent coil sensitivity factor denoted [s_{γ}(r+vt)]². These sensitivity functions can in general be expected to be different in the overlap region Rₒᵥₑᵣₗₐₚ. Accordingly, it is advantageous to separately reconstruct the two fields of view FOV_{eff1} and FOV_{eff2} using the reconstruction processor 40 applied separately to the k-space data of each scan, to produce two partially overlapping real-space images corresponding to the two fields of view FOV_{eff1} and FOV_{eff2}. The overlapping portions of these two images are then combined in image space to smooth any discontinuity in the overlap region Rₒᵥₑᵣₗₐₚ, for example using a sum-of-squares approach. To facilitate smoothing of the overlap region Rₒᵥₑᵣₗₐₚ, it is advantageous to oversample in the readout direction.

FIG. 3 diagrammatically illustrates a selected coronal slice of the resulting combined image, with the two fields of view FOV_{eff1} and FOV_{eff2} and the overlap region Rₒᵥₑᵣₗₐₚ superimposed, along with indications of the phase encoding (p.e.) and readout directions and the table velocity v selected for this particular example imaging configuration.

It will be appreciated that the reconstruction processor 40 can be physically embodied in various ways. For example, the reconstruction processor 40 can be a programmable digital computer or processor, and a storage medium such as an optical disk, magnetic disk, network server non-volatile storage, or the like (not shown) encodes instructions executable by the programmable computer or processor to perform the reconstruction processing.

If two phase encoding directions are employed to acquire three-dimensional image data, then a selected phase encoding direction can be undersampled, or both phase encoding directions can be undersampled. In this case, the weighted transform definition processor 60 defines two weighted transforms, one for each undersampled phase encoding direction. Other k-space trajectory configurations can be used, such as having the phase encoding direction parallel or antiparallel with the direction of continuous moving and the readout direction transverse to the direction of continuous moving. Still further, both the k-space sampling in the direction of continuous moving and the k-space sampling transverse to the direction of continuous moving can be undersampled. In this case, the weighted transform definition processor 60 defines two weighted transforms, one for each undersampled direction, and each of the two transform processors 50, 56 apply the appropriate weighted transform.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. An imaging method comprising:
continuously moving an imaging subject through a scanner field of view;
during the continuous moving, acquiring k-space data using a plurality of radio frequency coils, the acquiring including undersampling of k-space in at least one undersampled direction;
defining a weighted transform from k-space to real space for the at least one undersampled direction, the weighted transform incorporating patient position-dependent coil sensitivity weighting factors and a Fourier transform;
transforming the acquired k-space data along the direction of continuous moving to define hybrid space data having a real space dimension in the transformed direction of continuous moving and k-space dimensions in directions that are transverse to the direction of continuous moving; and
transforming the hybrid space data along the transverse direction to generate a reconstructed image;
the transformations including applying the defined weighted transform along an undersampled direction.

2. The imaging method as set forth in claim 1, wherein the transforming along the direction of continuous moving includes:
Fourier transforming the acquired k-space data along the direction of continuous moving to produce uncorrected hybrid space data; and
adjusting the uncorrected hybrid space data for the continuous moving.

3. The imaging method as set forth in claim 1, wherein the weighted transform includes:
patient position-dependent coil sensitivity weighting factors functionally dependent upon a reference position value offset by a spatial shift produced by the velocity of the continuous moving.

4. The imaging method as set forth in claim 3, wherein the weighted transform further includes:
a Fourier transform scaled by one of the patient position-dependent coil sensitivity weighting factors.

5. The imaging method as set forth in claim 1, wherein the coils include (i) one or more stationary coils that do not follow the continuous moving and (ii) one or more movable coils that follow the continuous moving, and the weighted transform includes:
one or more patient position-dependent coil sensitivity weighting factors associated with the one or more stationary coils; and
one or more patient position-independent coil sensitivity weighting factors associated with the one or more movable coils.

6. The imaging method as set forth in claim 1, further including:
acquiring a plurality of coil sensitivity calibration data acquisitions for a plurality of different positions of the imaging subject respective to the scanner field of view;
computing coil sensitivities for the plurality of radio frequency coils at each of the plurality of different positions based on the coil sensitivity calibration data acquisitions; and
deriving the patient position-dependent coil sensitivity weighting factors from the computed coil sensitivities at each of the plurality of different positions.

7. The imaging method as set forth in claim 6, wherein the acquiring of the plurality of coil sensitivity data acquisitions includes:
during the continuous moving, interleaving the coil sensitivity calibration data acquisitions amongst the acquiring of k-space data.

8. The imaging method as set forth in claim 1, wherein the acquiring of k-space data during the continuous moving includes:
acquiring a plurality of scans of the scanner field of view during the continuous moving, the transformations being applied to each scan to define a reconstructed image corresponding to each scan.

9. The imaging method as set forth in claim 8, wherein the plurality of radio frequency coils are stationary coils that do not follow the continuous moving, and the same weighted transform is used in the hybrid-transforming and the transforming of each scan.

10. The imaging method as set forth in claim 8, wherein a velocity of the continuous moving is selected to provide partial overlap of spatially neighboring images reconstructed from the plurality of scans, and the imaging method further includes:
combining in image space the overlapping image portions of spatially neighboring reconstructed images.

11. The imaging method as set forth in claim 10, wherein the at least one undersampled direction is the transverse direction, and the acquiring of k-space data during the continuous moving using a plurality of radio frequency coils includes:
oversampling k-space in the direction of continuous moving.

12. The imaging method as set forth in claim 1, wherein (i) the acquiring of k-space data during the continuous moving includes acquiring k-space data along Cartesian coordinates with undersampling of k-space in the phase-encoding direction, and (ii) the transforming employing the defined weighted transform produces an unfolded real space dimension in the phase-encoding direction.

13. The imaging method as set forth in claim 12, wherein the phase-encoding direction is the transverse direction, and the weighted transform corresponds to solving the matrix equation:
$${m}_{i , γ , κ , λ}^{hyb} = {\sum }_{λ} {E}_{i , γ , κ , λ} \cdot {ρ}_{i , λ}$$
for ρ_{i, λ}, where m_{i, γ, κ, λ}^{hyb} denotes the hybrid space data, i indexes phase-encoding lines in the hybrid space data, λ indexes lateral positions along the phase-encoding lines of the hybrid space data, ρ_{i, λ} denotes the signal density in line i at lateral position λ, γ indexes the plurality of radio frequency coils, κ indexes phase-encoding line acquisitions, and E_{i, γ, κ, λ} is an encoding matrix corresponding to:
E_{i, γ, κ, λ}=s_{γ}(r_{i, λ}−v·t_{κ})·exp(ik(t_{κ})·r_{i, λ})
where v denotes a velocity of the continuous moving, k(t_{κ}) denotes a phase-encoding step, t_{κ} denotes the time of acquisition of the phase-encoding line acquisition indexed by κ, r_{i, λ} denotes the spatial position corresponding to line i and lateral position λ, and s_{γ} denotes coil sensitivities.

14. The imaging method as set forth in claim 12, wherein the undersampled phase-encoding direction is the transverse direction, and a readout direction of the acquiring of k-space data along Cartesian coordinates is parallel with the direction of continuous moving.

15. A magnetic resonance imaging scanner for performing the imaging method set forth in claim 1.

16. A processor programmed to perform an image data processing method on k-space data acquired during continuous moving of an imaging subject using a plurality of radio frequency coils and including undersampling of k-space in at least one undersampled direction, the image data processing method including: (i) defining a weighted transform from k-space to real space for the at least one undersampled direction, the weighted transform incorporating patient position-dependent coil sensitivity weighting factors and a Fourier transform; (ii) transforming the acquired k-space data along the direction of continuous moving to define hybrid space data having a real space dimension in the transformed direction of continuous moving and a k-space dimension in a transverse direction that is transverse to the direction of continuous moving; and (iii) transforming the hybrid space data along the transverse direction to generate a reconstructed image; the method employing the defined weighted transform along an undersampled direction.

17. A magnetic resonance imaging scanner comprising:
a patient support for imaging an imaging subject continuously through a scanner field of view;
a plurality of radio frequency coils positioned to acquire k-space data which is undersampled in at least one undersampled direction; and
the processor according to claim 16.

18. A storage medium encoding instructions executable by an associated digital processor to perform an image data processing method on k-space data acquired during continuous moving of an imaging subject using a plurality of radio frequency coils and including undersampling of k-space in at least one undersampled direction, the image data processing method including: hybrid transforming the acquired k-space data along the direction of continuous moving to define hybrid space data having a real space dimension in the transformed direction of continuous moving and a k-space dimension in a transverse direction that is transverse to the direction of continuous moving; defining a weighted transform from k-space of all radio frequency coils to real space for the at least one undersampled direction, the weighted transform incorporating patient position-dependent coil sensitivity weighting factors and including a Fourier transform of the hybrid space data along the transverse direction to generate a reconstructed image; the method employing the defined weighted transform along an undersampled direction.
